(19) United States
(12) Patent Application Publication
(10) Pub. No.: US 2010/0190849 A1
(43) Pub. Date: Jul. 29, 2010

(54) Novel Clerodanes and Methods for Repelling Arthropods

(76) Inventors: Charles L. Cantrell, Oxford, MS (US); Jerome A. Klun, Potomac, MD (US); Stephen O. Duke, Oxford, MS (US)

Correspondence Address: USDA, ARS, OTT, 5601 SUNNYSIDE AVE, RM 4-1159, BELTSVILLE, MD, 20705-5131, US

(21) Appl. No.: 12/708,726

(22) Filed: Feb. 19, 2010

Related U.S. Application Data
(63) Continuation-in-part of application No. 11/374,866, filed on Mar. 14, 2006.

(51) Int. Cl. A01N 43/20; A01N 31/04; A01N 37/00; A01P 17/00

(52) U.S. Cl. 514/475; 514/729; 514/557

(57) ABSTRACT

A method for repelling arthropods involving treating a subject or an object with an arthropod repelling composition containing an arthropod repelling effective amount of at least one clerodane of the formula

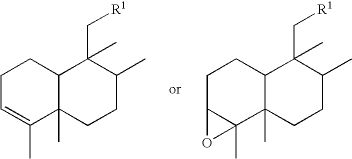

in which R¹ is H, halogen, formyl, a straight chain or branched C₁₋₄ saturated alkyl, a straight chain or branched C₂₋₄ unsaturated alkyl, or an aryl containing 6-10 carbon atoms in the ring skeleton thereof, wherein R¹ is unsubstituted or substituted with one or more substituents, which are the same or different, selected from the group consisting of oxo (═O), OR², CO₂R², and OC(O)R², wherein R² is H, a straight chain or branched C₁₋₃₀ saturated alkyl, a straight chain or branched C₂₋₃₀ unsaturated alkyl, or an aryl comprising 6-10 carbon atoms in the ring skeleton thereof; wherein R² is unsubstituted or substituted with one or more substituents selected from the group consisting of halogen, amino, hydroxyl, oxo (═O), thio, cyano and nitro; optionally a carrier, optionally an arthropod repellant, and optionally an insecticide. Preferably the compound is 13,14,15,16-tetranorclerod-3-en-12-al (callicarpenal), 13,14,15,16-tetranorclerod-3-en-12-ol, 13,14,15,16-tetranorclerod-3-en-12-oic acid, β-epoxycallicarpenal, α-epoxycallicarpenal, or mixtures thereof. Also a compound of the above formula. Also an arthropod repellant composition containing an arthropod repelling effective amount of at least one of the compounds of the above formula and a carrier. The present invention does not involve the use of any compound isolated from Callicarpa species other than callicarpenal, intermedeol, or spathulenol.

### REFERENCE TO RELATED APPLICATION

This application claims the benefit of U.S. patent application Ser. No. 11/374,866, filed 14 Mar. 2006, and U.S. Provisional Application No. 60/671849, filed 19 Apr. 2005, which are incorporated herein by reference in their entirety.

### BACKGROUND OF THE INVENTION

The present invention relates to a method for repelling arthropods involving treating a subject or an object with an arthropod repelling composition containing an arthropod repelling effective amount of at least one compound having the formula

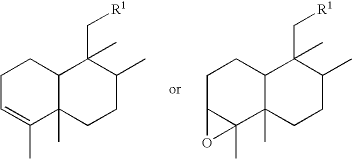

wherein R¹ is H, halogen, formyl, a straight chain or branched C₁₋₄ saturated alkyl, a straight chain or branched C₂₋₄ unsaturated alky, or an aryl containing 6-10 carbon atoms in the ring skeleton thereof, wherein R¹ is unsubstituted or substituted with one or more substituents, which are the same or different, selected from the group consisting of oxo (═O), OR², CO₂R², and OC(O)R², wherein R² is H, a straight chain or branched C₁₋₃₀ saturated alky, a straight chain or branched C₂₋₃₀ unsaturated alkyl, or an aryl comprising 6-10 carbon atoms in the ring skeleton thereof: wherein R² is unsubstituted or substituted with one or more substituents selected from the group consisting of halogen, amino, hydroxyl, oxo (═O), thio, cyano and nitro; or mixtures thereof: optionally a carrier, optionally an arthropod repellent, and optionally an insecticide. Preferably the compound is 13,14,15,16-tetranorclerod-3-en-12al (callicarpenal), 13,14,15,16-tetranorclerod-3en12-ol, 13,14,15,16-tetranorclerod-3-en-12-oic acid, β-epoxycallicarpenal, α-epoxycallicarpenal, or mixtures thereof. The present invention also relates to compounds of the above formula. Furthermore, the present invention relates to an arthropod repellant composition containing an arthropod repelling effective amount of at least one of the compounds of the above formula and a carrier. The present invention does not involve the use of any compound isolated from Callicarpa species other than callicarpenal (optional), intermedeol (optional), or spathulenol (optional).

Insect repellants are widely used throughout the United States and throughout the world. In some regions, the use of insect repellants is critical to avoiding or reducing the occurrence of disease carried by insects. For example the Centers for Disease Control (CDC) receives nearly 10,000 reports of Lyme disease (transmitted by deer ticks) and 1000 reports of encephalitis (transmitted by mosquitoes) annually.

Currently, the most common insect repellent is N,N-diethyl-meta-toluamide (DEET), DEET was designed to be applicable to the skin of subjects, and is designed to repel rather than kill insects. Although in use for some time, concern has recently emerged about the potential toxicity of DEET to children. Recently the US Environmental Protection Agency (EPA) determined that it would no longer allow child safety claims on labels tor DEET-containing products.

Thus there is a need for alternatives to chemicals such as DEET to use against insects such as mosquitoes.

### SUMMARY OF THE INVENTION

In accordance with the present invention there is provided a method for repelling arthropods involving treating a subject or an object with ah arthropod repelling composition containing an arthropod repelling effective amount of at least one compound having the formula

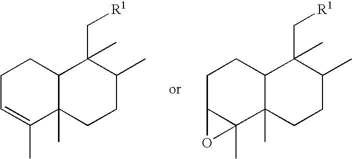

wherein R¹ is H, halogen, formyl, a straight chain or branched C₁₋₄ saturated alkyl, a straight chain or branched C₂₋₄ unsaturated alkyl or an aryl containing 6-10 carbon atoms in the ring skeleton thereof, wherein R¹ is unsubstituted or substituted with one or more substituents, which are the same or different, selected irons, the group consisting of oxo (═O), OR², CO₂R², and OC(O)R², wherein R² is H, a straight chain or branched C₁₋₃₀ saturated alkyl, a straight chain or branched C₂₋₃₀ unsaturated alkyl, or an aryl comprising 6-10 carbon atoms in the ring skeleton thereof: wherein R² is unsubstituted or substituted with one or more substituents selected from the group consisting of halogen, amino, hydroxyl, oxo (═O), thio, cyano and nitro; or mixtures thereof; optionally a carrier, optionally an arthropod repellant, and optionally an insecticide. Preferably the compound is callicarpenal, 13,14,15-16-tetranorclerod-3-en-12-ol, 13,14,15,16-tetranorclerod-3-en-12-oic acid, β-epoxycallicarpenal, α-epoxycallicarpenal or mixtures thereof.

Also in accordance with the present invention there is provided compounds of the above formula.

Still also in accordance with the present invention there is provided an arthropod repellent composition containing an arthropod repelling effective amount of at least one of the compounds of the above formula and a carrier.

### BRIEF DESCRIPTION OF THE DRAWINGS

FIG. 1 shows compounds isolated from Callicarpa americana and C. japonica.

FIG. 2 shows GC-MS (Gas Chromatography-Mass Spectroscopy) total ion chromatograms for C. americana and C. japonica essential oil extracts (A=α-humulene; B=humulene epoxide II; C=intermedeol ((4S,5S,7R,10S)-eudesm-11-en-4-ol); D=callicarpenal (13,14,15,16-tetranorclerod-3en-12-al); E=spathulenol (1R,4S,5R,6R,7R)-aromadendr-10(14)-en-4-ol)).

FIG. 3 shows head-to-head comparison on the repellency of callicarpenal and octanoic acid against fire ant workers in two choice bioassays (n=5). An asterisk indicates the repellency of callicarpenal was significantly greater than that of octanoic acid (Paired t-test).

FIG. 4 shows head-to-head comparison on the repellency of intermedeol and octanoic acid against fire ant workers in two choice bioassays (n=5). An asterisk indicates the repellency of intermedeol was significantly greater than that of octanoic acid (Paired t-test).

### DETAILED DESCRIPTION OF THE INVENTION

A method for repelling arthropods is disclosed involving treating a subject or an object with an arthropod repelling composition containing an arthropod repelling effective amount of at least one compound of the formula

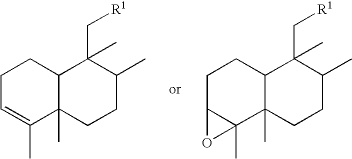

wherein R¹ is H, halogen, formyl, a straight chain or branched C₁₋₄ saturated alkyl, a straight chain or branched C₂₋₄ unsaturated alkyl, or an aryl containing 6-10 carbon atoms in the ring skeleton thereof, wherein R¹ is unsubstituted or substituted with one or more substituents, which are the same or different, selected from the group/consisting of oxo (═O), OR², CO₂R², and OC(O)R², wherein R² is H, a straight chain or branched C₁₋₃₀ saturated alkyl, a straight chain or branched C₂₋₃₀ unsaturated alkyl, or an aryl comprising 6-10 carbon atoms in the ring skeleton thereof; wherein R² is unsubstituted or substituted with one or more substituents selected from the group consisting of halogen, amino, hydroxyl, oxo (αO), thio, cyano and nitro; or mixtures of such clerodenes; optionally a carrier, optionally an arthropod repellant and optionally an insecticide. Preferably, wherein R¹ is H, halogen, formyl, or an unsubstituted or substituted methyl with one or more substituents, which are the same or different, selected from the group consisting of oxo (═O), OR², CO₂R², and OC(O)R², wherein R² is H, a straight chain or branched C₁₋₆ saturated alkyl, a straight chain or branched C₂₋₆ unsaturated alkyl, or an aryl comprising 6-10 carbon atoms in the ring skeleton thereof; wherein R² is unsubstituted or substituted, with one or more substituents selected from the group consisting of halogen, amino, hydroxyl, oxo (═O), duo, cyano and nitro. More preferably, wherein R¹ is H, bromine, chlorine, formyl, or an unsubstituted or substituted methyl with one or more substituents which are the same or different, selected from the group consisting of hydrogen, bromine, chlorine, oxo (═O), OR², CO₂R², and OC(O)R², wherein R² is H, methyl, bromine, chlorine, amino, hydroxyl, oxo (═O), thio, cyano and nitro. Preferably the compound is callicarpenal 13,14,15,16-tetranorclerod-3-en-12-ol, 13,14,15,16-tetranorclerod-3-en-12-oic acid, β-epoxycallicarpenal α-epoxycallicarpenal, or mixtures thereof. Also a compound of the above formula. Also an arthropod repellant composition containing an arthropod repelling effective amount of at least one of the compounds of the above formula and a carrier.

The method can therefore be used for repelling harmful or troublesome arthropods such as blood-sucking and biting insects, ticks and mites.

Blood-sucking insects include mosquitoes (for example Aedes, Culex and Anopheles species), including but not limited to Tiger mosquitoes, Aedes aboriginis, Aedes aegypti, Aedes albopictus, Aedes cantator, Aedes sierrensis, Aedes sollicitans, Aedes squamiger, Aedes sticticus, Aedes vexans, Anopheles quadrimaculatus, Culex pipiens, and Culex quinquefaxciatus; owl gnats (Phlebotoma), blackfly (Culicoides species, buffalo gnats (Simulium species), biting flies (for example Stomoxys calcitrans), tsetse flies (Glossina species), horseflies (Tabanus, Haematopota and Chrysops species), house flies (for example Musca domestica and Fannia canicularis), meat flies (for example Sarcophaga carnaria), flies which cause myiasis (for example Lucilia cuprina, Chrysomyia chhropyga, Hypoderma bovis, Hypoderma lineatum, Dermatobia hominis, Oestrus ovis, Gasterophilus intestinalis and Cochliomyia hominovorax), bugs (for example Cimex lectularius, Rhodnius prolixus and Triatoma infestans), lice (for example Pediculus numanus, Haematopinus suis and Damalina ovis) louse flies (for example Melaphagus orinus), fleas (for example Pulex irritans, Cthenocephalidescanis and Xenopsylla cheopis) and sand fleas (for example Dermatophilus penetrans).

Biting insects include cockroaches (for example Blatella germanica, Periplaneta americana, Blatta orientalis and Supella supellectilium), beetles (for example Sitophilus granarius, Tenebrio molitor, Dermestes lardarius, Stegobium paniceum, Anobium puntactum and Hylotrupes bajulus), termites (for example Reticulitermes lucifugus) and ants (for example Lasius niger).

Ticks include, for example, Ornithodorus moubata, Ixodes ricinus, Boophilus microplus and Amblyomma hebreum, and mites include, for example, Sarcoptes scabiei and Dermanyssus gallinae.

Preferably the composition is used against mosquitoes, for example Aedes, Culex and Amblyomma hebreum, and red imported fire ants, Solenopsis invicta Buren, black imported fire ants, Solenopsis richteri Forel.

Subjects to be treated with active compounds of the present invention include mammalian subjects such as human and animal subjects (e.g., dogs, eats, horses, cattle). Subjects may be directly or indirectly treated, such as by applying the active compound to the skin of the subject, or by applying the active compound to an article (object) worn by or otherwise protecting the subject.

Active compounds of the present invention include callicarpenal. The active compounds may be synthetic compounds synthesized using reactions similar to those in the examples below, Callicarpenal may be Isolated from Callicarpa americana or C. japonica. Preferably, the only compounds used in the present invention that are isolated from Callicarpa species (e.g., C. americana, C. japonica) are the compounds callicarpenal (optional), intermedeol (optional), or spathulenol (optional), and especially callicarpenal (optional).

The term “effective amount” as used herein, means the minimum amount of the active compounds needed to repel arthropods (e.g., Aedes aegypti (Linnaeus)); for example, repel arthropods from a mammalian subject (e.g., mammalian skin which has been treated topically with the compounds of the present invention) when compared to the same mammalian subject which is untreated. Effective concentrations of the active compounds in the compositions may vary between about 0.001 and about 99% (e.g., 0.001-99%) by weight, preferably between about 0.01 and about 99% (e.g., 0.01-99%), preferably between about 0.1 and about 99% (e.g., 0.1-99%), preferably between about 0.5 and about 90% (e.g., 0.5-90%). Of course, the precise amount of the active compounds needed will vary in accordance with the particular composition used; the number of hours or days of repelling activity needed; and the environment in which the subject is located. The precise amount of the active compounds needed can easily be determined by one skilled in the art given the teaching of this application. For example, one skilled m the art could follow the procedures utilized below.

The compositions may be applied to the subject's skin, or may be applied to objects such as garments, belts, collars, or other articles worn by the subject. Application to subjects or objects may be carried out by spraying, dusting, sprinkling or the like.

The active compounds according to the present invention may be employed alone or in mixtures with one another and/or with such solid and/or liquid dispersible carrier vehicles known in the art, and/or with other known compatible active agents (e.g., repellents or other arthropod control agents including insecticides, chemosterilants or the like), if desired, in the form of particular dosage preparations tor specific application made therefrom, such as solutions, emulsions, suspensions, powders, pastes, and granules as described herein or as otherwise known in the art which are thus ready for use. When used, these other known compatible active agents should he used in an amount which, as readily determined by one skilled in the arts, will not interfere with the effectiveness of the active compounds.

The active compounds according to the invention, which can be used in undiluted or diluted form, can he converted into formulations customary, for example, for repellents. They can be used in all the presentation forms customary in cosmetics, for example in the form of solutions, emulsions, gels, ointments, pastes, creams, powders, sticks, sprays or aerosols from spray cans.

For use in the non-cosmetic sector, the active compounds can be incorporated, for example, into granules, oily spraying agents or slow release fomentations,

The compositions are prepared in a known manner by mixing or diluting the active compounds according to the invention with solvents (for example xylene, chlorobenzenes, paraffins, methanol, ethanol, isopropanol or water), carriers (for example kaolins, aluminas, talc, chalk, highly disperse silicic acid and silicates), emulsifying agents (for example polyoxyethylene fatty acid esters, polyoxyethylene fatty alcohol ethers, alkylsulphonates and arylsulphonates) and dispersing agents (for example lignin, sulphite waste liquors and methylcellulose).

The compositions of the present invention generally contain a carrier material (e.g., physiologically acceptable carrier) and the active compounds. The carrier component can be a liquid or a solid material. As is known in the art, the vehicle or carrier to be used refers to a substrate such as a gel, polymers, or the like. All of these substrates have been used to release insect repellents and are well known in the art. As noted above, the only compounds used In the present invention that are isolated from Callicarpa species (e.g., C. americana, C. japonica) are the compounds callicarpenal, intermedeol, or spathulenol, and especially callicarpenal; thus the carrier does not contain any other compound isolated from Callicarpa species although water might be used as a carrier.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLE 1

General Procedures: ¹H- and ¹³C-NMR spectra were recorded in CDCl₃ on a Bruker Avance 400 MHz spectrometer, High resolution mass spectra were obtained on either a JEOL AccuTOF (JMS-T100LC) or an Agilent LC/MSD TOF. Column chromatography was performed using a Biotage, Inc. Horizon™ Pump equipped with a Horizon™ Flash Go Hector and fixed wavelength (254 nm) detector.

GC-MS Analysis; Oil extracts of C. americana and C. japonica were analyzed by GC-MS on a Varian CP-3800 GC coupled to a Varian Saturn 2000 MS/MS. GC was equipped with a DB-5 column (30 m×0.25 mm fused silica capillary column, film thickness of 0.25 μm) operated using the following conditions: injector temperature, 240° C.; column temperature, 60-240° C. at 3° C./min then held at 240° C. tor 5 min; carrier gas, He; injection volume, 1 μL (splitless). MS ionization energy set to 70 eV.

Plant Extracts: Leaves of C. americana were collected in July from a single large plant (4 m. tall×5 m. wide) growing in Lafayette County, Mississippi at latitude 34°20′25″ N and longitude 89″40′17″ W. A voucher specimen from one of the collections was deposited in the Pullen Herbarium in Oxford, Miss. and assigned voucher numbers MISS #71,495 by the museum curator, Dr. Lucile McCook.

Leaves of C. japonica were collected in August from three separate cultivated plants growing in Lafayette County, Mississippi at latitude 34° 20′ 25″ N and longitude 89° 40′ 16″ W. Cultivated plants were grown in full sun and. averaged 5 ft. tall and 4 ft wide. Voucher specimens from both collections were deposited in the Pullen Herbarium in Oxford, Miss. and were assigned voucher numbers MISS #63823 and MISS #71,496 by the herbarium curator, Dr. Lucile McCook.

Essential Oil Preparation: Steam distillations were conducted in a Nickerson-Likens type apparatus (Nickerson G. B., and S. T. Likens, J. Chromatography, 21: 1-5 (1966)). Fresh cut leaves of C, americana or C. japonica were immediately frozen in sealed plastic bags upon collection until needed. C. americana leaves (495 g) were placed in a 2 L round bottom flask along with 1 L of H₂O. The distillate was continuously extracted during an 8 hour distillation with 30 mL of pentane into a 50 mL pear-shaped flask heated in a water bath maintained at 70° C. This process was repeated using 495 g of additional leaves to provide 937 mg of crude essential oils. In an identical manner. 440 g or C. japonica fresh leaves were extracted providing 382 mg of crude essential oil.

C. americana Oil Fractionation: A portion (696 mg) of the C. americana essential oil collected in 2004 was subjected to silica get (25×150 mm, 60 Å, 40-63 μm) column chromatography A hexane/EtOAc linear gradient consisting of the following steps was used: 100/0 to 90/10, 600 mL; 90/10 to 80/20, 408 mL: 80/20 to 50/50, 360 mL; 50/50 to 0/100, 1008 mL. A total of96 24 mL test tubes were collected and combined into 7 fractions (Fr. A 203 mg, Fr. B 149 mg, Fr. C 34 mg, Fr. D 19 mg, Fr. E (intermedeol) 56 mg, Fr. F 156 mg, Fr. G 24 mg) based on TLC similarity. This fractionation, was performed twice using the procedure above (different amounts of starting materials) giving slightly different yields of individual fractions (A to G). This was necessary as nearly all of the original oil was used in the bioassays (Table 2), Fr. A was further purified using silica gel (25×150 mm, 60 Å, 40-63 μm) column chromatography with 1500 mL of hexane resulting in 25 mg of α-humulene. Fr. B was purified using a silica gel (25×150 mm, 60 Å, 40-63 μm) column chromatography gradient from 100% hexane to 20% EtOAc (1602 mL) resulting in Fr. B-1 (56 mg) and Fr. B-2 (57 mg, humulene epoxide II). Fr. B-1 was further purified using a silica gel (25×150 mm, 60 Å, 40-63 μm) column chromatography gradient from 100% hexane to 15% EtOAc (2001 mL) providing 38 mg of callicarpenal.

C. japonica Oil. Fractionation: A portion (270 mg) of the C. japonica essential, oil collected in 2003 was subjected to silica gel(25×150 mm, 60 Å, 40-63 μm) column chromatography. A hexane/EtOAc linear gradient consisting of the following steps was used: 190/0 to 90/10, 600 mL; 90/10 to 80/20, 408 mL; 80/20 to 50/50, 360 mL; 50/50 to 0/100, 1008 mL. A total of 9624 mL test tubes were collected and combined into 7 fractions (Fr. A 52 mg, Fr. 14 mg, Fr. C (humulene epoxide II) 18 mg, Fr. D 13 mg, Fr. E 36 mg, Fr. F 29 mg, Fr. G 62 mg) based on TLC similarity. Fr. E and F were combined and purified using a silica gel (25×150 mm, 60 Å, 40-63 μm) column chromatography hexane/EtOAc linear gradient (100/0 to 80/20, 900 mL; 80/20 to 50/50, 402 mL; 50/50 to 0/100,309 mL) resulting in 3 fractions: Fr, EF-1, 4 mg (intermedeol); Fr. EF-2, 28 mg; and Fr. EF-3, 11 mg (spathulenol). Fr. EF-2 (28 mg) was further purified, using a silica gel (25×150 mm, 60 Å, 40-63 μm) column chromatography hexane/Et₂O linear gradient (100/0 to 80/20, 1200 mL; 80/20 to 50/50, 402 mL; 50/50 to 0/100, 309 ml,) resulting in 3 fractions (Fr. 1, 11 mg (intermedeol): Fr. 2, 5 mg; and Fr. 3, 10 mg (spathulenol).

α-humulene: Structure was assigned by comparison of ¹³C NMR data with that reported in the literature (Randriamiharisoa, R., et al., Magnetic Resonance in Chemistry, 24: 275-276 (1986)) as well as searching electron ionization MS date with that reported in the 2002 NIST Mass Spectral Library.

Humulene epoxide II intermedeol, and spathulenol; MS, ¹H and ¹³C NMR data were in complete agreement with that previously reported In the literature for humulene epoxide II, intermedeol, and spathulenol (Itokawa, H., et al., Phytochemistry, 27; 435-438 (1988); Damodaran, N. P., and S. Dev. Tetrahedron, 24: 4123-4132 (1968): Kesselmans, R. P. W., et al., Journal of Organic Chemistry, 56: 7237-7244 (1991); Krebs, H. C., et al., Magnetic Resonance in Chemistry, 28; 124-128 (1990); Ragasa, C. Y., et al., Chemical & Pharmaceutical Bulletin, 51: 1208-1210(2003)),

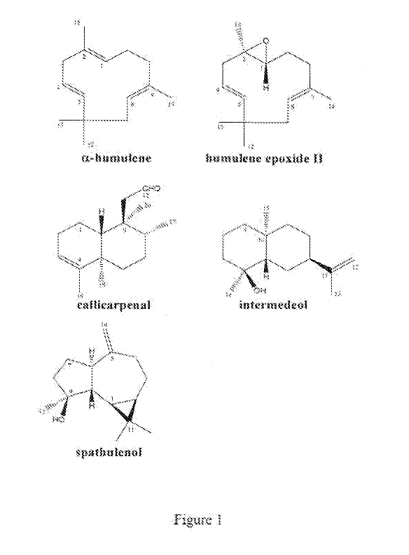

Callicarpenal: 13,14,15,16-tetranorclerod-3-en-12-al (FIG. 1). ¹H and ¹³C NMR data, see Table 3. High resolution APCI-MS m/z 235.2063 [M+H]⁺, calculated for C₁₆H₂₇O, 235.2062.

Insects: Ae. aegypti(L.) (red eye Liverpool strain) and An. stephensi Liston used in the study were from colonies maintained at the Walter Reed Army Institute of Research, Silver Spring, Md. The insects were reared by feeding larvae ground tropical fish flakes (Tetramin Tropical Fish Flakes, Tetra Sales, Blacksburg, Va., www.tetra-fish.com)(Gerberg, E. j., et al., Manual for mosquito rearing and experimental techniques. Amer. Mosq. Control Assoc. Bull. No. 5 (revised), 1994, AMCA. inc., Lake Charles, La.). Adults were maintained in a photoperiod of 12:12 (L:D) h at 27° C. and 80% RH with cotton pads moistened with 10% aqueous sucrose solution. Mated females were 5-15 d old when they were used in bioassays. Ae. aegypti females had access only to water 24 h and neither food nor water for another 24 h before testing. An. stephensi females were provided with water alone 24 h before testing.

Mosquito Bioassay Methods: Experiment were conducted by using, a six-celled in vitro Klun & Debboun (K & D) module bioassay system developed by klun et al. (Klum J. A., et al., Journal of the American Mosquito Control Association. 21: 64-70 (2005)) for quantitative, evaluation of mosquito-repellent (anti-biting) properties of candidate repellent compounds for human use. The assay system consist of a six-well blood reservoir with each of the 3×4 cm wells containing 6 ml human blood cells water-bath warmed (38° C. reservoir and covered with a collagen membrane. The blood-membrane unit simulates a human host for mosquito feeding. Anti-biting activity of standard repellent compounds, measured in the in-vitro K & D module system, are known to be comparable to activities observed when rested on the skin of human volunteers (Klun et al.).

Plant extracts, fractions, or isolated pure plant derived compounds in 95% ethanol solution were each randomly applied to six-4×5 cm areas of organdy cloth and positioned over the membrane-covered blood. A replicate consisted of six treatments: four test chemicals or extract fractions, 95% ethanol treated cloth as control and unfractionated plant extract or a standard repellent compound, (1S, 2′S)-2-methylpiperidinyl-3-cyclohexen-1-carboxamide (SS220) at 25 nmol/cm² cloth. The 25 nmol SS220/cm² cloth dose was used as a standard, because it was known from human volunteer and in vitro assays to consistently suppress mosquito biting by 80% or more compared to controls in replicated assays (Klun, J. A., et al., Journal of the American Mosquito Control Association, 21: 64-70 (2005)). SS220 possesses repellent activity against An. stephensi equivalent to bench mark repellent compounds Deet and Bayrepel, and against Aedes aegypti, SS220 was more effective than Bayrepel and as effective as Deer (Klun J. A., et al., Journal of Medical Entomology, 40: 203-299 (2003)). Routinely, a six-celled K & D module containing five mosquitoes/cell was positioned over cloth treatments covering the six blood-membrane wells,, and trap doors of the K&D modules were opened to expose the treatments to the sets of mosquitoes. After a 3 minute exposure, the number of mosquitoes biting through cloth treatments in each cell was recorded and mosquitoes were prodded back into the cells. In Experiment 8, we retained all mosquitoes in their respective K&D module cells, each fitted with a water-moist piece of cotton, and observed the mosquitoes for total mosquito toxic knockdown at 6 min, 1 hr, and 24 hr post-treatment exposure. Experiments were replicated 12, 18, 32, or 56 times. Thus, 60, 90, 160. or 280 mosquitoes were tested against each treatment depending on the experiment, and the proportion of mosquitoes not biting for each treatment was calculated. For each experiment, conducted in different time periods, logistic regression was used to make two sets of one degree-of-freedom contrasts (t-tests): treatments vs. control and treatments vs. SS220 for anti-biting activity within each experiment. The level of significance was set at P=0.05. In all, we conducted 8 biological experiments, and all experiments used Ae. aegypti as the test mosquito with exception of Experiment 7 which used An. stephensi.

Experiments 1 and 2: These dose x response experiments compared C. japonica and C. americana essential oil preparations at 1, 10, and 100 μg oil/cm² cloth versus ethanol (95%) control and 25-nmol SS-220/cm² cloth for anti-biting activity (SS-220 is 1-(3-cyclohexen-1-ylcarbonyl)-2-methylpiperidine). Each experiment was replicated 18 times.

Experiments 3, 4, and 5: In each of these experiments, chromatographic fractions of essential oil at their respective percentage compositions of 100 μg essential oil/cm² cloth, 100 μg unfractionated essential oil/cm² cloth, 25 nmol SS-220/cm² cloth and control were compared for mosquito anti-biting activity. Each experiment was replicated 18 times.

Experiments 6 and 7: These experiments compared the anti-biting activities of SS-220, and plant-isolated callicarpenal, humulene epoxide II, intermedeol and spathulenol at 25 nmol compound/cm² cloth versus control against Ae. aegypti and An. stephensi, respectively. Experiment 6 was replicated 32 times and 7 had 56 replicates

Experiment 8: This experiment (12 replicates) compared the antibiting activities of a mixture (25 nmol/cm² cloth) of 11.5% callicarpenal, 47.1% intermedeol, and 41.4% spathulenol. The percentage composition of the mixture was a normalized percentage of active components in C. japonica essential oil based upon GC-MS analysis total ion Area % analysis based on largest peaks. Other treatments in the experiment were SS220, callicarpenal, intermedeol, and spathulenol each at 25 nmol/cm² cloth versus control. In addition to measurement of anti-biting activity, the number of dead mosquitoes observed at three time intervals were recorded for the six treatments.

Results: and discussion: The essential oil extracts from both C. americana and C. japonica were evaluated for their Ae. aegypti repellent activities at 100, 10, and 1 μg/cm² cloth (Table 1). Higher anti-biting activity was observed for C. japonica oil although both oils demonstrated significant biological activity compared to control, and both oils at 100 μg/cm² cloth exhibited anti-biting activity equal to SS220. Due to minute oil quantities available and based on the data of Table 1, fractionation using silica, gel was performed on C. americana essential oil. Fractions were screened at concentrations representing their weight percentages in the parent oil from the original fractionation. Analysis of the proportion of mosquitoes not biting in Experiments 3, 4, and 5 (Table 2) showed that fractions B, E, and F contained the most active constituents and were therefore responsible for the activity of the crude oil. Consequently, all three fractions, as well as others, were thoroughly investigated.

Fraction B was further purified using silica gel column chromatography resulting in the isolation of a colorless oil having a molecular weight of m/z 220 by GC-MS. ¹H NMR spectral analysis suggested the presence of three olefinic methines (δ 5.28 m, δ 5.17 m, δ 4.99 m), one oxygenated methine (δ2.55 m), and four methyls, one of which appeared to be olefinic. 90° and 135° DEPT and ¹⁴C NMR analysis indicated the presence of four olefinic carbons, two oxygenated carbons (δ 63.5 s, 62.2 d), four aliphatic methylene carbons, four methyls, and one quaternary singlet (δ 36.7). Final identification of this compound as humulene epoxide II was accomplished by comparison of spectroscopic data with that previously reported in the literature (Itokawa, H., et al., Phytochemistry, 27: 435-438 (1988); Damodaran, N. P., and S. Dev, Tetrahedron, 24: 4123-4132 (1968)).

A second purified compound (colorless oil) from fraction B gave a molecular ion at m/z 234 and an intense fragment at m/z 190 when analyzed by GC-MS. Analysis by positive-ion high resolution APCI-MS gave a molecular ion at m/z 235.2063 (calculated for C₁₆H₂₇O, 235.2062) corresponding to [M+H]⁺. The above information suggested a molecular formula of C₁₆H₂₆O and four sites of unsaturation. Initial inspection of the ¹H NMR spectrum indicated the presence of one aldehyde triplet (δ 9.83, J=3.2 Hz, H-12),one olefinic proton (δ 5.18 br s, H-3), one olefinic methyl singlet (δ 1.57, H-8), one methyl doublet (δ 0.94, J=6.4 Hz, H-17), and two methyl singlets (δ 1.01, H-19; δ 0.83, H-20) (Table 3). As expected from high resolution MS data, ¹³C NMR spectral analysis indicated a total of 16 carbons. The combination of 90° and 135° DEPT and ¹³C NMR. data indicated the presence of one carbonyl (δ 203.8 d), two olefinic (δ 120.8 d, δ 143.8 s), five aliphatic methylene, two aliphatic methine, two quartenary, and four methyl carbons (Table 3).

¹H COSY correlations were observed between the aldehyde triplet at δ 9.83 (H-12) and methylene protons, at δ 2.33 (H-11) and δ 2.46 (H-11) which were not further coupled, suggesting a quaternary center, HMBC correlations (Table 3) observed between H-11 methylene protons and δ 39.3 (C-8), δ 41.9<C-9), δ 49.6 (C-10), and δ 17.4 (H-20) established the attachment of C-11 (δ 52.0 t) to C-9 which was further attached to carbons 8, 10, and 20. The methine proton at δ 1.61 (H-8) gave a strong COSY coupling to the methyl doublet at δ 0.94 (H-17). The HMBC correlations observed, between the methine proton at δ 1.43 (H-10) and carbons at δ 26.8 (C-2), δ 38.7 (C-5), δ 41.9 (C-9) δ 52.0 (C-11), δ 20.1 (C-19), and δ 17.4 (C-20) as well as those observed between H-19 (δ 1.01 s) and δ 143.8 (C-4) δ 38.7 (C-5), δ 36.7 (C-6), and δ 49.6 (C-10) were critical to the establishment of an A-B ring structure consistent with that of a clerodane diterpenoid, HMBC correlations between H-3 (δ 5.18 br s) and those at δ 19.2 (C-1), δ 26.8 (C-2), and δ 38.7 (C-5) confirmed the location of the double bond within the A ring. Unambiguous ¹H, ¹³C, and HMBC NMR spectral assignment data are reported in Table 3 and firmly establish the structure as that drawn in FIG. 1 for which we have assigned the trivial name callicarpenal and systematic name 13,14.15,16-tetranorclerod-3-en-12-al.

Fraction E appeared to be a pure compound upon inspection by GC-MS, which indicated a molecular ion of m/z 222 [M]⁺. ¹H NMR analysis indicated the presence of two olefinic protons (δ 4.92 s, δ 4.87 s), a single olefinic methyl (δ 1.75 s), and two aliphatic methyls. 90° and 135° DEPT and ¹³C NMR analysis revealed the presence of two olefinic carbons (δ 146.9 s, δ 110.8 t), one quaternary oxygenated carbon (δ 72.1 s), and twelve additional carbons, three methyls, six methylenes, two methines, and one quaternary carbon. Structural confirmation was ultimately provided by comparison of ¹H and ¹³C NMR data with that reported in the literature for intermedeol (Kesselmans, R. P. W., et al., Journal of Organic Chemistry, 56: 7237-7244 (1991)), providing unambiguous structural confirmation (FIG. 1).

For completeness, Fractions A and F were also investigated. Fraction F contained impure intermedeol while fraction A was further purified allowing for the isolation of a compound exhibiting a molecular ion at m/z 204 by GC-MS analysis. A successful search of the 2002 NIST Mass Spectral Library indicated a strong match to α-humulene. Final structure confirmation was obtained by comparison of ¹H and ¹³C NMR chemical shift data with that reported in the literature for α-humulene (Randriamiharisoa, R., et al., Magnetic Resonance in Chemistry, 24; 275-276 (1986)) allowing for its structure to be assigned that shown in FIG. 1.

A similar approach to that described above for the investigation of C. americana was also performed on the essential oil extract of C. japonica. However, due to the small quantity of essential oil and raw material available, a bioassay-guided approach was not chosen. The initial fractionation of C. japonica oil was done in an identical manner to that for C. americana, resulting in fractions A to G. Many of the same compounds isolated from C. americana were also isolated from C. japonica except for a compound present in fractions E and F. These fractions were combined due to similarities in their TLC and further purified using silica gel column chromatography resulting in the isolation of intermedeol and a compound giving a strong molecular ion of m/z 220 by GC-MS analysis. Initial inspection of 1H NMR spectroscopic data indicated the presence of two olefinic protons (δ 4.68 s, δ 4.66 s) and three aliphatic methyls. ¹³C NMR analysis revealed the presence of two olefinic carbons (δ 153.4, δ 106.3), one oxygenated carbon (δ 80.9), and twelve additonal carbons. Final structural confirmation was accomplished by comparison of ¹H and ¹³C NMR spectral data with that reported in the literature allowing for assignment of the structure to that of spathulenol (Krebs, H. C., et al., Magnetic Resonance in Chemistry, 28: 124-128 (1990); Ragasa, C. Y., eta l., Chemical & Pharmaceutical Bulletin, 51: 1208-1210 (2003)) (FIG. 1).

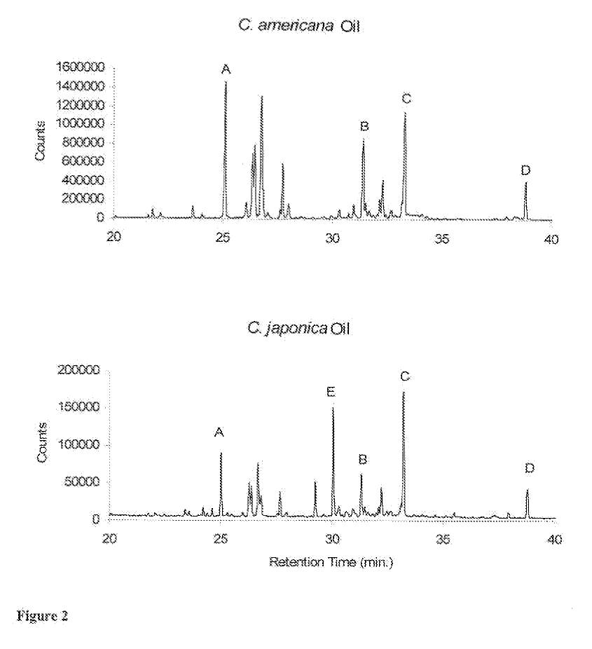

GC-MS analysis of crude essential oils was performed for comparison of isolated constituents present in each species (FIG. 2). Clearly, α-humulene, humulene epoxide II, intermedeol, and callicarpenal were all present in oils from both species. Further inspection of the chromatograms revealed large amounts of spathulenol in C. japonica oil and absence of it in C. americana oil. This and other minor differences between the two oils may explain why C. japonica oil was more effective against Ae. aegypti than was oil from C. americana (Table 1).

Compounds isolated from bioactive fractions (humulene epoxide II, intermedeol, callicarpenal, and spathulenol) were tested for repellent efficacy against both Ae. aegypti and An. stephensi in Experiments 6 and 7, respectively (Tables 4 and 5).

Experiment 6 (Table 4) revealed that humulene epoxide II possessed no repellent activity; callicarpenal and intermedeol surprisingly had significant activity and were only slightly less effective than spathulenol or SS220 which were equally active against Ae. aegypti. Experiment 7 showed that callicarpenal, intermedeol and spathulenol were as effective as SS220 against An. stephensi and Ae. aegypti. Humulene epoxide II was not different from the control.

Moreover, experiments 6 and 7 (Tables 4 and 5), taken together, showed a consistent trend that callicarpenal, intermedeol, and spathulenol were effective in fending off biting by An. stephensi and Ae. aegypti, and the three compounds were generally comparable to SS220. Humulene epoxide II was uniformly ineffective against either species of mosquito.

The “proportion not biting” data in experiment 8 against Ae. aegypti were similar to the results observed in experiment 6 inasmuch as callicarpenal and intermedeol surprisingly expressed high repellent activity that was comparable to SS220.Spathulenol did not perform as well as it had in experiment 6. Without being bound by theory, we believe the apparent diminished comparative efficacy of spathulenol in experiment 8 was due to the fact that statistical power for treatment resolution in experiment, made up of only 12 replicates, was significantly less than that of experiment 6 where 32 replicate observations were made. Use 25 nmol mixture/cm² cloth, like spathulenol alone, was significantly different from the control. The data also showed that preserving a sesquiterpene mixture to Ae. aegypti did not result in a synergistic repellent effect. More importantly, experiment 8 unambiguously showed that none of the sequiterepenes alone or as a mixture possessed knock-down toxic activity (Table 6).

Clearly, this study resulted in the isolation of the arthropod (e.g., mosquito) repellent constituent callicarpenal produced by the plants C. americana and C. japonica. In addition, analysis of a second species from the same genus, C. japonica, led to the isolation of yet another bioactive compound, spathulenol. Callicarpenal, intermedeol and spathulenol proved to be highly effective repellents against An. stephensi and Ae. aegypti. These compounds may represent useful alternatives to conventional, synthetic insect repellents currently on the market.

### EXAMPLE 2

Sodium borohydride reduction of callicarpenal: Callicarpenal (21.9 mg) was seated in dry methanol (10 mL) with excess NaBH₄ (150 mg) at room temperature for 95 min. The reaction was worked up by adding H₂O and extracting with CH₃Cl. The concentrated dried CH₃Cl extract was separated by preparative TLC (H:EtOAc, 80:20) which furnished the primary alcohol, 13,14,15,16-tetranosclerod-3-en-12-ol;

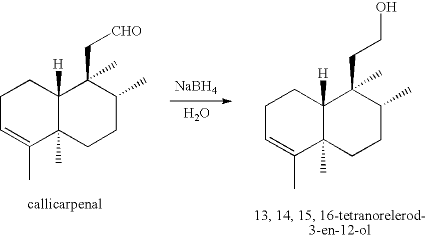

13,14,15,16-tetranorclerod-3en-12ol. High resolution ESI-MS m/z 237.2059 [M+H]*, calculated for C₁₆H₂₉O, 237.2218. ¹H NMR (400 MHz in CDCl₃): δ 5.22 s (1H), 3.65 m (2H)ⱼ, 2.08 m (1H), 2.04 m (1H), 1.61 br s (1H), 1.03 s (3H), 0.90 d (J=6.0 Hz, 3H), 0.78 s (3H). ¹³C NMR (400 MHz in CDCl₂): δ 144.5 s, 120.7 d, 58.9 t, 47.8 d, 41.2 t, 39.0 s, 38.5 s, 37.6 d, 36.9 t, 27.7 t, 27.0 t, 20.2 q, 18.8 t, 18.5 q, 18.1 q, 16.4 q.

Oxidation of callicarpenal to 13,14,15,16-tetranorclerod-3-en-12-oic acid: To a solution of 50.7 mg of callicarpenal, 2-methyl-2-butene (0.338 ml), NaH₂PO₄ (91.9 mg) in 0.518 ml of tert-butanol and H₂O (2 ml: 1 ml) was added sodium chlorite (60.7 mg) and the mixture was stirred at 25° C. for 1 hr. Reaction was allowed to proceed overnight, 10 ml of H₂O were added to the reaction mixture, and the organic residue was extracted with ethyl acetate (3×10 ml). The organic layers were collected, dried (MgSO₄), concentrated under vacuum, and the residue was purified as follows. Crude reaction mixture (50.7 mg) was adsorbed to silica gel and applied to a silica gel chromatography column (25 mm×150 mm, 60 Å 40-63 μm). Elution of the column was performed using increasing polarity mixtures of hexane:EtOAc in a series at two linear steps as follows: (step 1) 100:0 to 0:100 using 1728 ml, (step 2) 0:100 to 0:100 using 576 ml. A total of 96, 24 ml test tubes were collected, and on the basis of thin-layer chromatography (TLC) similarities recombined into six tractions (A, 1-18, 1.9 mg); (B, 19-20, 3.3 mg); (C, 21-27, 2.3 mg); (D, 28-32, 10.4 mg); (E, 33-51, 6.0 mg); and (F, 52-96, 4.5 mg). Fraction D afforded 10.4 mg of 13,14,15,16-tetranorclerod-3-en-12-oic acid.

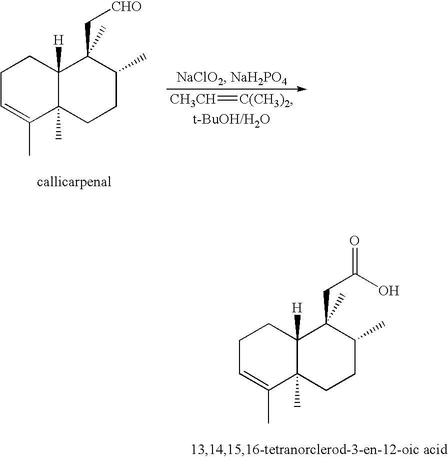

13,14,15,16-tetranorclerod-3en-12-oic. High resolution ESI-MS m/z 249.1977 [M−H]*, calculated for C₁₆H₂₅O₂, 249.1854. ¹H NMR (400 MHz in CDCl₃): δ 5.20 (s, 1H), 2.47 (d, 1H,J=13.2 Hz), 2.34 (d, 1H,J=13.2 Hz), 2.05 Z(m, 2H), 1.59 (s (3H). 0.91 (d. 3H,J=6.4 Hz), 0.80 (s, 3H). ¹³C NMR (400 MHz in CDCl₃): δ 178.0, 143.9, 121.1, 48.2 343.1, 41.3, 38.7, 37.7, 36.6, 27.6, 26.9, 20.1, 19.5, 18.2, 17.6, 16.5.

Aedes aegypti repellency: 13,14,15,16-tetranorclerod-3-en-12ol and 13,14,15,16-tetranorclerod-3-en-12-oic acid were evaluated for biting deterrent efficacy against Ae. aegypti. Results listed in Table 7 suggested that both synthetic isomers were surprisingly equivalent to both callicarpenal and picaridin (2-(2-hydroxyethyl)-1piperidinecarboxylic acid 1-methylpropyl ester. Without being bound by theory, this indicated that the oxidation state at C-12 is not critical to maintain activity.

### EXAMPLE 3

m-CPBA Oxidation of Callicarpenal to Epoxides: A solution of 75.4 mg of callicarpenal in 2 ml CH₂Cl₂ was added to a solution of 1.5 molar equivalents m-CPBA in 2 ml CH₂Cl₂ and stirred in an ice bath for 1 h. The reaction mixture was washed three times with 5 ml 0.01 M NaOH solution and once with 5 ml of distilled H₂O. TLC of the reaction mixture revealed at least two products. Accordingly, the crude mixture (69.4 mg;) was adsorbed to silica gel and applied to a silica gel chromatography column (25 mm×150 mm, 60 Å, 40-63 μm). Elution of the column was performed using increasing polarity mixtures of hexane/ether in a series of three linear steps as follows: (step 1) 100:0 to 80:20 using 1200 ml, (step 2) 80:20 to 50:50 using 1599 ml (step 3) 50:50 to 0.100 using 600 ml. A total of 142 24 ml test tubes were collected, and on the bash of thin-layer chromatography (TLC) similarities, recombined into three fractions (A, 68-76; B, 77-78; and C. 79-88), Fraction A afforded 11.9 mg of α-epoxycallicarpenal and traction C provided 19.6 mg of β-epoxycallicarpenal.

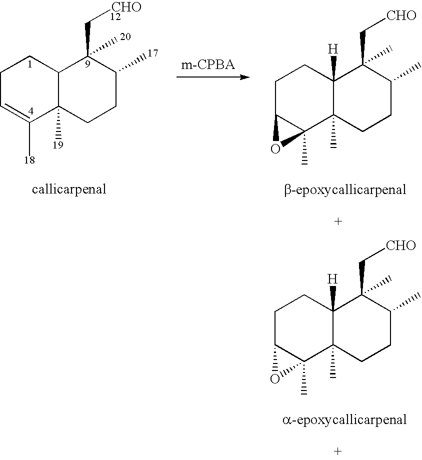

β-epoxycallicarpenal. High resolution ESI-MS m/s 251.2101 [M+H]⁺, calculated for C₁₆H₂₇O₂, 251.2011. ¹H NMR (400 MHz in CDCl₃): δ 9.81 (t, 1H, J=3.2 Hz); 2.86 (m, 1H), 2.29 (m, 2H), 1.16(s, 3H), 1.06 (s, 3H), 0.92 (d, 3H, J=6.8 Hz), 0.77 (s, 3H). ¹³C NMR (400 MHz in CDCl₃): δ 203.4 d, 65.6 s, 60.5 d, 52.4 t, 41.2 d, 41.0 s, 39.0 d, 37.4 s, 34.2 t, 26.7 t, 23.0 t, 18.1 q, 17.5 q, 17.1 t, 16.7 q, 16.2 q.

α-epoxycallicarpenal. High resolution ESI-MS m/s 251.2018 [M+H]⁺, calculated for C₁₆H₂₇O₂, 251.2011. ¹H NMR (400 MHz in CDCl₃): δ 9.82 (t, 1H, J=3.2 Hz); 2.92 (s, 1H), 2.38 (m, 2H), 2.13(m, 1H), 1.17 (s, 3H), 1.06 (s, 3H), 0.94 (d, 3H, J=6.4 Hz), 0.75 (s, 3H). ¹³C NMR (400 MHz in CDCl₃): δ 203.4 d, 66.0 s, 62.0 d, 51.5 t, 50.4 d, 42.2 s, 38.7 d, 37.5 s, 36.8 t, 27.9 t, 27.9 t, 19.6 q, 17.6 q, 16.7 t, 16.2 q, 16.1 q.

Aedes aegypti repellency: β-epoxycallicarpenal and α-epoxycallicarpenal were evaluated for biting, deterrent efficacy against Ae. aegypti. Results listed in Table 8 suggested that both synthetic epoxides were surprisingly equivalent to callicarpenal. Without being bound by theory, this suggested that activity was conserved regardless of whether an epoxide or a double bond was present at C-3.

### EXAMPLE 4

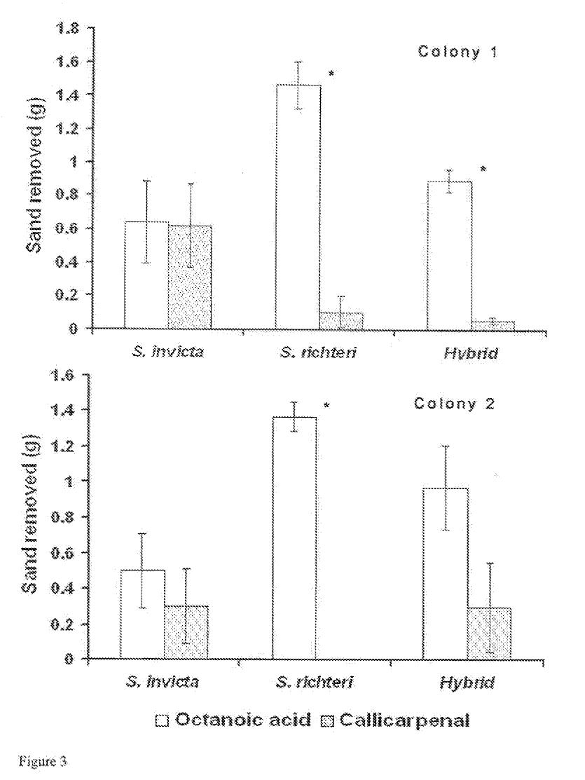

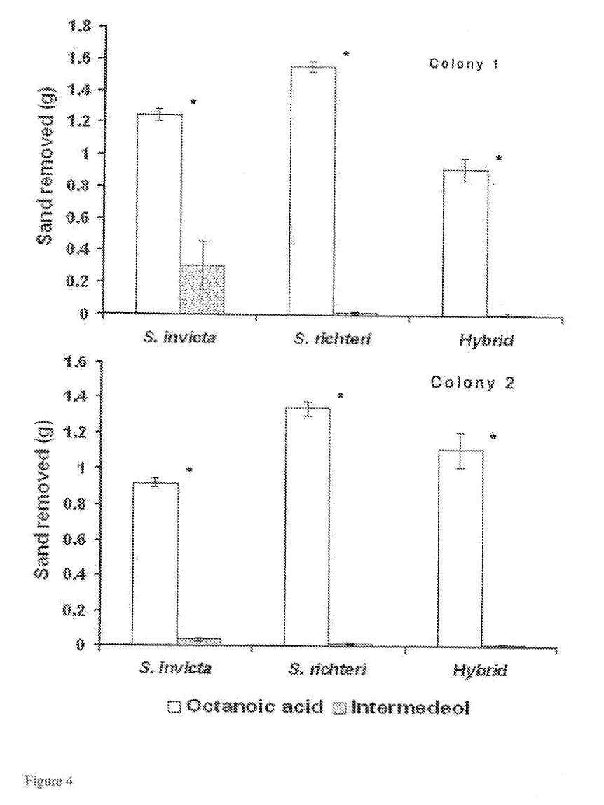

The repellency of the two terpenoids, callicarpenal and intermedeol, against workers of red imported fire ants, Solenopsis invicta Buren, black imported fire ants, Solenopsis rickeri Forel, and a hybrid of these two species was evaluated using multiple-choice digging bioassays (Tables 9 & 10). A total of six colonies, two colonies from each species and hybrid, were tested, Callicarpenal surprisingly showed significant repellency at ≧50.00 ppm against S. invicta and ≧6.25 ppm against S. richteri and the hybrid (Table 9). Intermedeol surprisingly showed significant repellency at ≧0.75 to ≧1.50 ppm against S. invicta and the hybrid, ≧6.25 ppm against S. richteri, and ≧1.50 to ≧6.25 ppm against the hybrid (Table 10). Callicarpenal and intermedeol were compared with octanoic acid, a known fire ant repellant, at the 25.00 ppm level using two-choice digging bioassays (FIGS. 3 and 4). Callicarpenal surprisingly showed significantly greater repellency than octanoic acid against both S. richteri colonies and one hybrid colony: however, there was no significant difference between callicarpenal and octanoic acid for both S. invicta colonies and the other hybrid colony (FIG. 3). Intermedeol surprisingly showed significantly greater repellency than octanoic acid against all colonies of S. invicta, S. richteri and the hybrid colonies (FIG. 4),

Ants: Two Solenopsis invicta colonies were collected in Sharkey County, Mississippi, and two Solenopsis richteri colonies were collected in Granada County, Mississippi. Two colonies of the hybrid (S. invicta×S. richteri) colony were collected in Sunflower County, Mississippi. Fire ant mounds were shoveled and placed in 19-L plastic buckets. The inside wall of the bucket was then coated with baby powder (Cumberland Swan Holdings, Inc., Smyrna, Tenn.) to prevent ant escape. Following the water-drip method developed by Bank et al. (Banks, W. A., et al., Techniques for collecting, rearing, and handling imported fire ants, USDA SEA AATS-S-21 (1981)), ants were separated and then placed in a 44.5×60.0×13.0 cm plastic tray with inside walls coated with Fluon® (Ag Fluoropolymers, Chadds Ford, Pa.). Distilled water and 15% (w/v) sucrose water solution in separated test tubes which were plugged with cotton balls were placed in the trays. Heliocoverpa zea (Boddie) and tobacco budworm, Heliothis virescens (Fabricius) pupae were used as food sources. Inside each tray were one to three 14.0×2.0 cm Petri dishes with 1.0 cm of hardener dental plaster (Castone®; Dentsply International Inc. York, Pa.) on the bottom. Also, in the center of the Petri dish was a 5.0-cm diameter brood chamber. Two 8-mm access holes were made on the wall of the petri dish above the dental plaster. The Petri dish lid was painted black (1302 Gloss Black Spray Enamel, Louisville, Ky.)to block the light. All colonies were maintained at 22-25° C.

S. invicta and S. richteri are two closely related species. Fortunately, these two species and their hybrid can be readily separated using profiles of worker venom alkaloids and cuticular hydrocarbons (Vander Meer, R. K., et al., Flo. Entomol., 68: 501-506 (1985)l Ross, K. G., et al., Evolution, 41: 280-293 (1985)). The separation of species and the hybrid followed the method described by Ross et al. The social form of two S. invicta colonies was determined using PCR. Primers described in Valles et al. (Valles, S. M., et al., J. Invertebr. Pathol., 81: 196-201 (2002)) were used to amplify Gp-9 alleles indicating monogyne or polygyne colony status.

Chemicals: Octanoic acid (98.00% purity) and dichloromethane (99.9% purity, A.C.S. HPLC grade), which was used as a solvent for all test compounds, were purchased from Sigma-Aldrich (St. Louis, Mo.).

Repellency of callicarpenal and intermedeol: The test material was incorporated into sand within a centrifuge tube which had an entry hole through the cap and into a Petri dish where fire ants were located. Fire ant workers dug and removed sand from the tube through the entry hole. The differences in the amount of removed sand among treated and control tubes were used to evaluate chemical repellency. Four 2 ml centrifuge tubes were mounted under a 14.0×2.3 cm Petri dish using glue (Arrow Fastener Co., inc., Saddle Brook, N.J.). Tubes were 5.0 cm away from the center of the Petri dish and at equal distance from each other. A 3-mm diameter access hole was drilled for each centrifuge tube, which went through the bottom of the Petri dish and the cap of the tube. The inner side of the Petri dish was coated with Fluon. Three concentrations of a test compound and one control were set up in each apparatus. Six concentrations, including 0.75, 1.50, 3.15, 6.25, 12.50, and 25.00 ppm, were tested in two separated bioassays for each species and hybrid; however three more concentrations of callicarpenal, 50.00, 100.00, and 150.00 pm, were tested for S. invicta. Sand (Premium Play Sand, Plassein International, Longview, Tex.) was first sieved through a ™35 U.S.A. standard testing sieve (Thomas Scientific, Swedesboro, N.J.) and then washed with distilled water and dried at 350° C. for 12 h. A 3 ml dichloromethane solution of callicarpenal or intermedeol was mixed with 30 g sand in an aluminum pan. The sand was stirred every 2 min to facilitate the evaporation of the solvent under a fume hood. After dichloromethane evaporated (5 minutes), 1.92 ml distilled water was added and mixed with sand. Sand in the control tube was treated only with dichloromethane. In each tube a mean (±SD) 2.78 g (±0.06 g) wet sand was added. There was no open space inside the tube. Locations of each concentration were randomized. Fifty fire ant workers were introduced into the center of the Petri Dish. The experiment was conducted at 22±0.8° C. (mean±SD) temperature and 45.4%±11.87% relative humidity. After 24 h, sand in each vial was collected, dried at 150° C. for at least 4 hour, and weighed. A total of six colonies, two colonies from each species and the hybrid, were tested. Both S. invicta colonies were monogyne. Social forms of S. richteri and hybrid were not determine. The experiment was replicated five times for each colony. The general linear model analysis of variance and LSD test (PROC GLM; SAS Institute 1999) were used to compare the amount of sand removed by ants among treatments. Significance was determined at P<0.05. If overall the F-test was not significant, no further pairwise mean comparison was conducted, and all test concentrations were reported as being non-repellant.

Head-to-head comparison on repellency of callicarpenal and intermedeol against octanoic acid: The bioassay apparatus was similar as described above, except a smaller Petri dish (8.7×2.3 cm) was used and only two choices were presented: one was sand treated with callicarpenal or intermedeol and the other with octanoic acid. Two choices were opposite each other across the center of the Petri dish and each was 3.0 cm away from the center. All compounds were tested at a 25.00 ppm level. Sand preparation was similar as described above. Ants from the same colonies as above were used in this experiment. There were five replications for each pair of comparisons. A paired t-test (critical P-value=0.05) was used to compare the mean amount of sand removed between two tubes.

All of the references cited herein are incorporated by reference in their entirety. Also incorporated by reference in their entirety are the following references: Agresti A., Categorical. Data Analysis, 1990, John Wiley & Son, N.Y.; Banks, W. A., et al., Techniques for collecting, rearing, and handling imported fire ants, USDA SEA AATS-S-21 (1981); Bohlmann, F., et al., Phytochemistry, 22; 2243-2252 (1983); Damodaran, N. P., and S. Dev, Tetrahedron, 24: 4123-4132 (1968); Gerberg, E. J., et al., Manual for mosquito rearing and experimental techniques, Amer. Mosq. Control Assoc. Bull. No. 5 (revised), 1994, AMCA, Inc., Lake Charles, La.; Hagiwara, H., et al., J. Chem. Soc. Perkin Trans., 7: 757-764.(1995); Hagiwara, H., et al., J. Chem. Soc. Perkin Trans., 7: 757-764 (1995); Hayashi, K., et al., Journal of Antimicrobial Chemotherapy, 39: 821-824 (1997); Hosozawa, S., et al., Phytochemistry, 11: 2362 (1972); Itokawa, H., et al., Phytochemistry, 27: 435-438 (1988): Kesselmans, R. P. W., et al., Journal of Organic Chemistry; 56: 7237-7244 (1991); Kim, Y.-S., and D.-H. Shin, Journal of Agricultural and Food Chemistry, 52: 781-787 (2004); Klum J. A., et al., Journal of Medical Entomology, 40; 293-299 (2003); Klun, J. A., et al., Journal of the American Mosquito Control Association, 21: 64-70 (2005); Kobaisy, M., et al., Phytochemistry, 61: 37-40 (2002); Krebs, H. C., et al., Magnetic Resonance in Chemistry, 28; 124-128 (1990); Ling, T., et al., J. Am. Chem. Soc., 124; 12261-12267 (2002); Nagai, M., et al., Yakugaku Zasshi 93: 1087-1088 (1973); Nickerson, G. B., and S. T. Likens, J. Chromatography, 21, 1-5 (1966); Ragasa, C. Y,, et al., Chemical & Pharmaceutical Bulletin 51: 1208-1210 (2003); Randriamiharisoa, R., et al., Magnetic Resonance in Chemistry, 24; 275-276 (1986); Ross, K. G., et al., Evolution, 41: 280-293 (1985); Tellez, M. R., et al., Journal of Agricultural and Food Chemistry 48: 3008-3012 (2000): Valles, S. M., et al., J. Invertebr. Pathol., 81: 196-201 (2002); Vander Meer, R. K., et al., Flo. Entomol., 68; 501-506 (1985); JP2000026210; U.S. Pat. Nos. 4,800,662; 6,562,841 (Klun).

Thus, in view of the above, the present invention concerns (in part) the following:

A method for repelling arthropods comprising (or consisting essentially of or consisting of) treating a subject or an object with an anthropod composition comprising (or consisting essentially of or consisting of) an arthropod repelling effective amount of an active compound selected from the group consisting of at least one (isolated or purified or synthetic or isolated and purified) clerodane having the formula

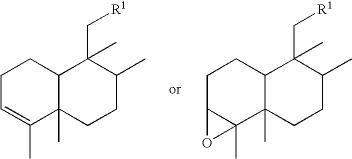

in which R¹ is H, halogen, formyl, a straight chain or branched C₁₋₄ saturated alkyl a straight chain or branched C₂₋₄ unsaturated alkyl, or an aryl containing 6-10 carbon atoms in the ring skeleton thereof, wherein R¹ is unsubstituted or substituted with one or more substituents, which are the same or different, selected from the group consisting of oxo, OR², CO₂R², and OC(O)R², wherein R² is H, a straight chain or branched C₁₋₃₀ saturated alkyl, a straight chain or branched C₂₋₃₀ unsaturated alkyl, or an aryl containing 6-10 carbon atoms in the ring skeleton thereof; wherein R² is unsubstituted or substituted with one or more substituents selected from the group consisting of halogen, amino, hydroxyl, oxo, thio, cyano and nitro; and mixtures thereof; optionally a carrier, optionally an arthropod repellant, and optionally an insecticide. As used herein, the term “isolated and purified” means isolated from another component or from other components of a naturally occurring source (such as a plant cell) or from a synthetic organic chemical reaction mixture, and processed through one or more purifying steps that separate the compound of the invention from other molecules associated with it. When isolated and purified, the compound of the invention is at least about 50% (e.g., at least 50%) pure, preferably at least about 55% (e.g., at least 55%) pure, preferably at least about 60% (e.g., at least 60%) pure, preferably at least about 65%.(e.g., at least 65%) pure, preferably at least about 70% (e.g., at least 70%) pure, preferably at least about 75% (e.g., at least 75%) pure, preferably at least about 80% (e.g., at least 80%) pure, preferably at least about 85% (e.g., at least 85%) pure, preferably at least about 90% (e.g.,. at least 90%) pure, preferably at least about 95% (e.g., at least 95%) pure, preferably at least about 96% (e.g., at least 96%) pure, preferably at least; about 97% (e.g., at least 97%) pure, preferably at least about 98% (e.g., at least 98%) pure, and more preferably at least about 99% (e.g., at least 99%) pure. The method does not involve the use of any compound isolated from Callicarpa species other than callicarpenal (optional), intermedeol (optional), and spathulenol (optional), and the composition does not contain any compound isolated from Callicarpa species other than callicarpenal (optional), intermedeol (optional), >and spathulenol (optional).

The above method, wherein said active compound is selected from the group consisting of callicarpenal, 13,14,15,16-tetranorclerod-3-en-12-ol, 13,14,15,16-tetranorclerod-3-en-12-oic acid, β-epoxycallicarpenal, α-epoxycallicarpenal and mixtures thereof.

The above method, wherein said active compound is callicarpenal. Wherein said callicarpenal is isolated from at least one member selected from the group consisting Of Callicarpa americana, Callicarpa japonica, or mixtures thereof.

The above method, wherein said composition contains a carrier (e.g., physiologically acceptable carrier) which does not involve the use of any compound isolated from Callicarpa species other than callicarpenal. (optional), intermedeol (optional), and spathulenol (optional).

The above method, wherein said subject is a mammalian subject. Wherein said mammalian subject is a human subject. Wherein said treating comprises applying said composition to the skin of said subject. Wherein said treating comprises application of said composition to an article, which article is worn by said human subject.

The above method, wherein the concentration of said active compound in said composition is from about 0.001% by weight to 99% by weight of the composition.

The above method, wherein said active compound is synthetic.

The above method, wherein said arthropods are mosquitoes or fire ants.

The above method, wherein said composition further comprises intermedeol.

The above method, wherein said composition does not contain intermedeol.

The above method, wherein said composition further comprises spathulenol.

The above method, wherein said composition does not contain spathulenol.

A composition for repelling arthropods comprising (or consisting essentially of or consisting of) an arthropod repelling effective amount of intermedeol and at least one member selected from the group consisting of callicarpenal, 13,14,15,16-tetranorclerod-3-en-12-ol, 13,14,15,16-tetranorclerod-3-en-12-oic acid, β-epoxycallicarpenal, α-epoxycallicarpenal, and mixtures thereof, optionally a carrier (e.g., physiologically acceptable carrier), optionally an arthropod repellant, and optionally an insecticide. The composition does not contain any compound isolated from Callicarpa species other than callicarpenal (optional), intermedeol (optional), and spathulenol (optional).

The above composition, wherein said intermedeol, callicarpenal, 13,14,15,16-tetranorclerod-3-en-12-ol, 13,14,15,16-tetranorclerod-3-en-12-oic acid, β-epoxycallicarpenal, and α-epoxycallicarpenal are synthetic.

The above composition, wherein said callicarpenal and intermedeol are isolated from at least one member selected from the group consisting of Callicarpa americana, Callicarpa japonica, or mixtures thereof.

The above composition, wherein said composition further comprises spathulenol.

The above composition, wherein said composition does not contain spathulenol.

The above composition, wherein said composition does not contain spathulenol.

A (isolated or purified or synthetic or isolated and purified) clerodane having the formula

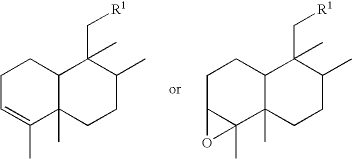

wherein R¹ is H, halogen, formyl, a straight chain or branched C₁₋₄ saturated alkyl, a straight chain or branched C₂₋₄ unsaturated alkyl, or an aryl containing 6-10 carbon atoms in the ring skeleton thereof wherein R¹ is unsubstituted or substituted with one or more substituents, which are the same or different, selected from the group consisting of oxo, OR², CO₂R², and OC(O)R², wherein R² is H, a straight chain or branched C₁₋₃₀ saturated alkyl, a straight chain or branched C₂₋₃₀ unsaturated alkyl, or an aryl comprising 6-10 carbon atoms in the ring skeleton thereof, wherein R² is unsubstituted or substituted with one or more substituents selected from the group consisting of halogen, amino, hydroxyl, oxo, thio, cyano and nitro.

The above clerodane, wherein said clerodane further comprises a carrier (e.g., physiologically acceptable carrier). The above clerodane does not involve the use of any compound isolated from Callicarpa species other than callicarpenal (optional), intermedeol (optional), and spathulenol (optional).

The above clerodane, wherein R¹ is H, halogen, formyl, or an unsubstituted or substituted methyl with one or more substituents, which are the same or different selected from the group consisting of oxo (=O), OR², CO₂R², and OC(O)R², wherein R² is H, a straight chain or branched C₁₋₆ saturated alkyl, a straight chain or branched C₂₋₆ unsaturated alkyl, or an aryl comprising 6-10 carbon atoms in the ring skeleton thereof; wherein R² is unsubstituted or substituted with one or more substituents selected from the group consisting of halogen, amino, hydroxyl, oxo (═O), thio, cyano and nitro.

The above clerodane, wherein R¹ is H, bromine, chlorine, formyl, or an unsubstituted or substituted methyl with one or more substituents, which are the same or different, selected from the group consisting of hydrogen, bromine, chlorine, oxo (=O). OR², CO₂R², and OC(O)R², wherein R² is H, methyl, bromine, chlorine, amino, hydroxyl, oxo (═O), thio, cyano and nitro.

The above clerodane, wherein said clerodane is selected from the group consisting of 13,14,15,16-tetranorclerod-3-en-12ol, β-epoxycallicarpenal, α-epoxycallicarpenal, and mixtures thereof

The above clerodane, wherein said clerodane is not callicarpenal or 13,14,15,16-tetranorclerod-3-en-12-oic acid.

Callicarpenal and optionally a carrier (e.g., physiologically acceptable carrier) but not any compound isolated from Callicarpa species other than callicarpenal, intermedeol (optional), and spathulenol (optional). Callicarpenal and a carrier (e.g., physiologically acceptable carrier) but not any compound isolated from Callicarpa species other than callicarpenal, intermedeol (optional), or spathulenol (optional).

An arthropod, repellent composition, comprising (or consisting essentially of or consisting of) an arthropod repelling effective amount of at least one (isolated or purified or synthetic or isolated and purified) clerodane having the formula

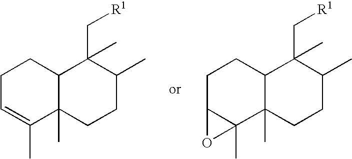

wherein R¹ is H, halogen, formyl, a straight chain or branched C₁₋₄ saturated alkyl, a straight chain or branched C₂₋₄ unsaturated alkyl, or an aryl containing 6-10 carbon atoms in the ring skeleton thereof, wherein R¹ is unsubstituted or substituted with one or more substituents, which are the same or different, selected from the group consisting of oxo, OR², CO₂R², and OC(O)R², wherein R² is H, a straight chain or branched C₁₋₃₀ saturated alkyl, a straight chain or branched C₂₋₃₀ unsaturated alkyl, or an aryl comprising 6-10 carbon atoms in the ring skeleton thereof, wherein R² is unsubstituted or substituted with one or more substituents selected from, the group consisting of halogen, amino, hydroxyl, oxo, thio, cyano and nitro; and a carrier (e.g., physiologically acceptable carrier). The composition does not contain any compound isolated from Callicarpa species other than callicarpenal (optional), intermedeol (optional), and spathulenol (optional).

The above composition, wherein R¹ is H, halogen, formyl, or an unsubstituted or substituted methyl with one or more substituents, which are the same or different, selected from the group consisting of oxo (═O), OR², CO₂R², and OC(O)R², wherein R² is H, a straight chain or branched C₁₋₆ saturated alkyl, a straight chain or branched C₂₋₆ unsaturated alkyl, or an aryl comprising 6-10 carbon atoms in the ring skeleton thereof; wherein R² is unsubstituted or substituted with one or more substituents selected from the group consisting of halogen, amino, hydroxyl, oxo (═O), thio, cyano and nitro.

The above composition, wherein R¹ is H, bromine, chlorine, formyl, or an unsubstituted or substituted methyl with one or more substituents, which are the same or different, selected from the group consisting of hydrogen, bromine, chlorine, oxo (═O), OR², CO₂R², and OC(O)R², wherein R² is H, methyl, bromine, chlorine, amino, hydroxyl, oxo (═O), thio, cyano and nitro.

The above composition, wherein said clerodane is selected from the group consisting of 13,14,15,16-tetranorclerod-3-en-12-ol, β-epoxycallicarpenal, α-epoxycallicarpenal, and mixtures thereof

The above composition, wherein said clerodane is not callicarpenal or 13,14,15,16-tetranorclerod-3-en-12-oic acid.

The above composition, which also contains intermedeol and/or spathulenol.

The above composition, which does not contain intermedeol.

The above composition, which does not contain spathulenol.

The above composition, which does not contain a carrier.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
C. japonica and C. americana Dose X Response
Essential Oil Preparations Against Aedes aegypti.

| | | | Proportion |
|---|---|---|---|
| Exp. | Treatment | Concentration | Not Biting |
| 1 | Control | — | 0.33^{a} |
| | SS220 | 25 nmole/cm² | 0.81^{c} |
| | C. japonica Oil | 1 μg/cm² | 0.34^{a} |
| | C. japonica Oil | 10 μg/cm² | 0.68^{b} |
| | C. japonica Oil | 100 μg/cm² | 0.83^{c} |
| 2 | Control | — | 0.40^{a} |
| | SS220 | 25 nmole/cm² | 0.90^{c} |
| | C. americana Oil | 1 μg/cm² | 0.46^{a} |
| | C. americana Oil | 10 μg/cm² | 0.69^{b} |
| | C. americana Oil | 100 μg/cm² | 0.77^{b} |

^{a}Not different from control.
^{b}Significantly different from control.
^{c}Not different from SS220.

TABLE 2
Insect Repellent Bioassay Results of C. americana
Essential Oil and Fractions Against Aedes aegypti.

| | | | | Proportion |
|---|---|---|---|---|
| Exp. | Treatment | Concentration | | Not Biting |
| 3 | Control | — | | 0.10^{a} |
| | SS220 | 25 | nmole/cm² | 1.00^{c} |
| | C. americana | 100 | μg/cm² | 0.98^{c} |
| | Oil | | | |
| | C. americana | 36.9 | μg/cm² | 0.13^{a} |
| | Fr. A | | | |
| | C. americana | 8.4 | μg/cm² | 0.97^{c} |
| | Fr. B | | | |
| 4 | Control | — | | 0.15^{a} |
| | SS220 | 25 | nmole/cm² | 0.92^{c} |
| | C. americana | 100 | μg/cm² | 0.93^{c} |
| | Oil | | | |
| | C. americana | 14.0 | μg/cm² | 0.48^{b} |
| | Fr. C | | | |
| | C. americana | 6.1 | μg/cm² | 0.62^{b} |
| | Fr. D | | | |
| | C. americana | 13.2 | μg/cm² | 0.87^{c} |
| | Fr. E | | | |
| 5 | Control | — | | 0.22^{a} |
| | SS220 | 25 | nmole/cm² | 0.95^{c} |
| | C. americana | 100 | μg/cm² | 0.0^{c} |
| | Oil | | | |
| | C. americana | 14.5 | μg/cm² | 0.87^{c} |
| | Fr. F | | | |
| | C. americana | 6.9 | μg/cm² | 0.45^{b} |
| | Fr. G | | | |

^{a}Not different from control.
^{b}Significantly different from control.
^{c}Not different from SS220.

TABLE 3
¹H (400 MHz), ¹³C (100 MHz), and HMBC NMR
Assignment Data for Callicarpenal (CDCl₃).

| Position | δ_{H} mult (J in Hz) | δ_{C} mult^{a} | | HMBC (¹H to ¹³C) |
|---|---|---|---|---|
| 1 | — | 19.2 | t | — |
| 2 | — | 26.8 | t | — |
| 3 | 5.18 br s | 120.8 | d | 1, 2, 5 |
| 4 | — | 143.8 | s | — |
| 5 | — | 38.7 | s | — |
| 6 | — | 36.7 | t | — |
| 7 | — | 27.6 | t | — |
| 8 | 1.61 m | 39.3 | d | — |
| 9 | — | 41.9 | s | — |
| 10 | 1.43 m | 49.6 | d | 2, 5, 9, 11, 19, 20 |
| 11 | 2.33 dd (3.6, 14.4), | 52.0 | t | 8, 9, 10, 12, 20 |
| | 2.46 dd (3.6, 14.4) | | | |
| 12 | 9.83 t (3.2) | 203.8 | d | 11 |
| 17 | 0.94 d (6.4) | 16.5 | q | 7, 8, 9 |
| 18 | 1.57 br s | 18.1 | q | 3, 4, 5 |
| 19 | 1.01 s | 20.1 | q | 4, 5, 6, 10 |
| 20 | 0.83 s | 17.4 | q | 8, 9, 10, 11 |

^{a}Carbon multiplicities deduced from DEPT NMR experiments.

TABLE 4
Insect Repellent Experiments Using
Isolated Compounds Against Aedes aegypti.

| | | Proportion |
|---|---|---|
| Exp. | Treatment | Not Biting |
| 6 | Control | 0.39^{a} |
| | SS220 | 0.80^{c} |
| | callicarpenal | 0.70^{b} |
| | humulene epoxide | 0.48^{a} |
| | II | |
| | intermedeol | 0.70^{b} |
| | spathulenol | 0.73^{c} |

^{a}Not different from control.
^{b}Significantly different from control.
^{c}Not different from SS220.

TABLE 5
Insect Repellent Experiments Using
Isolated Compounds Against Anopheles stephensi.

| | | Proportion |
|---|---|---|
| Exp. | Treatment | Not Biting |
| 7 | Control | 0.42^{a} |
| | SS220 | 0.78^{c} |
| | callicarpenal | 0.75^{c} |
| | humulene epoxide | 0.58^{a} |
| | II | |
| | intermedeol | 0.72^{c} |
| | spathulenol | 0.75^{c} |

^{a}Not different from control.
^{b}Significantly different from control.
^{c}Not different from SS220.

TABLE 6
Insect Repellent Experiments Using Isolated Compounds
Against Aedes aegypti.

| | | | Total | Total | |
|---|---|---|---|---|---|
| | | Proportion | Knock | knock | Total knock |
| Exp. | Treatment | Not Biting | down 6 min | down 1 hr | down 24 hr |
| 8 | control | 0.20^{a} | 0 | 1 | 2 |
| | SS-220 | 0.67^{c} | 0 | 1 | 2 |
| | mixture | 0.42^{b} | 0 | 3 | 6 |
| | callicarpenal | 0.73^{a} | 0 | 1 | 5 |
| | intermedeol | 0.62^{c} | 1 | 1 | 2 |
| | spathulenol | 0.48^{b} | 1 | 2 | 0 |

^{a}Not different from control.
^{b}Significantly different from control.
^{c}Not different from SS220.

TABLE 7
Insect Deterrent Experiments Using
Synthetic Compounds Against Ae. aegypti.

| Treatment | Proportion Not Biting |
|---|---|
| ethanol | 0.40^{a} |
| picaridin | 0.62^{b} |
| callicarpenal | 0.70^{b} |
| 13,14,15,16-tetranorclerod-3-en-12-ol | 0.68^{b} |
| 13,14,15,16-tetranorclerod-3-en-12-oic acid | 0.60^{b} |

^{a}Not different from control.
^{b}Significantly different from control.

TABLE 8
Insect Deterrent Experiments Using
Synthetic Compounds Against Ae. aegypti.

| Treatment | Proportion Not Biting |
|---|---|
| ethanol | 0.31^{a} |
| callicarpenal | 0.73^{b} |
| β-epoxycallicarpenal | 0.70^{b} |
| α-epoxycallicarpenal | 0.68^{b} |

^{a}Not different from control.
^{b}Significantly different from control.

TABLE 9
Repellency of callicarpanel against fire ant workers,
based on mean (±SE) weight (g) of sand removed
by ants 24 h after release.

| Species | Colony | Exp. | Conc. (ppm) | Sand removed (SE) |
|---|---|---|---|---|
| S. invicta | 1 | 1 | Control | 0.30 (0.13) |
| | | | 3.15 | 0.40 (0.20) |
| | | | 1.50 | 0.24 (0.15) |
| | | | 0.75 | 0.19 (0.07) |
| | | 2 | Control | 0.22 (0.13) |
| | | | 25.00 | 0.08 (0.05) |
| | | | 12.50 | 0.48 (0.19) |
| | | | 6.25 | 0.21 (0.12) |
| | | 3 | Control | 0.84 (0.05) |
| | | | 50.00 | 0.04 (0.004)* |
| | | | 100.00 | 0.02 (0.008)* |
| | | | 150.00 | 0.03 (0.007)* |
| S. invicta | 2 | 4 | Control | 0.36 (0.12) |
| | | | 3.15 | 0.36 (0.11) |
| | | | 1.50 | 0.32 (0.15) |
| | | | 0.75 | 0.32 (0.16) |
| | | 5 | Control | 0.33 (0.19) |
| | | | 25.00 | 0.02 (0.01) |
| | | | 12.50 | 0.45 (0.18) |
| | | | 6.25 | 0.24 (0.21) |
| | | 6 | Control | 0.60 (0.15) |
| | | | 50.00 | 0.02 (0.007)* |
| | | | 100.00 | 0.08 (0.06)* |
| | | | 150.00 | 0.07 (0.03)* |
| S. richteri | 1 | 7 | Control | 0.50 (0.16) |
| | | | 3.15 | 0.21 (0.13) |
| | | | 1.50 | 0.28 (0.12) |
| | | | 0.75 | 0.40 (0.16) |
| | | 8 | Control | 1.03 (0.05) |
| | | | 25.00 | 0.08 (0.04)* |
| | | | 12.50 | 0.40 (0.17)* |
| | | | 6.25 | 0.10 (0.04)* |
| S. richteri | 2 | 9 | Control | 0.78 (0.25) |
| | | | 3.15 | 0.17 (0.11) |
| | | | 1.50 | 0.85 (0.22) |
| | | | 0.75 | 0.27 (0.16) |
| | | 10 | Control | 0.82 (0.03) |
| | | | 25.00 | 0.01 (0.002)* |
| | | | 12.50 | 0.10 (0.04)* |
| | | | 6.25 | 0.10 (0.04)* |
| Hybrid | 1 | 11 | Control | 0.68 (0.04) |
| | | | 3.15 | 0.30 (0.11) |
| | | | 1.50 | 0.59 (0.10) |
| | | | 0.75 | 0.66 (0.09) |
| | | 12 | Control | 1.00 (0.03) |
| | | | 25.00 | 0.39 (0.14)* |
| | | | 12.50 | 0.26 (0.05)* |
| | | | 6.25 | 0.53 (0.13)* |
| Hybrid | 2 | 13 | Control | 0.69 (0.09) |
| | | | 3.15 | 0.58 (0.12) |
| | | | 1.50 | 0.36 (0.09) |
| | | | 0.75 | 0.53 (0.14) |
| | | 14 | Control | 0.92 (0.06) |
| | | | 25.00 | 0.21 (0.11)* |
| | | | 12.50 | 0.30 (0.11)* |
| | | | 6.25 | 0.47 (0.09)* |

*Significantly different from the control (0.00 ppm).
SE: standard error.

TABLE 10
Repellency of intermedeol against fire ant workers,
based on mean (±SE) weight (g) of sand removed
by ants 24 h after release.

| Species | Colony | Exp. | Conc. (ppm) | Sand removed (SE) |
|---|---|---|---|---|
| S. invicta | 1 | 15 | Control | 0.68 (0.04) |
| | | | 3.15 | 0.20 (0.06)* |
| | | | 1.50 | 0.36 (0.09)* |
| | | | 0.75 | 0.56 (0.06) |
| | | 16 | Control | 1.13 (0.13) |
| | | | 25.00 | 0.18 (0.09)* |
| | | | 12.50 | 0.25 (0.13)* |
| | | | 6.25 | 0.66 (0.15)* |
| S. invicta | 2 | 17 | Control | 0.85 (0.02) |
| | | | 3.15 | 0.35 (0.12)* |
| | | | 1.50 | 0.35 (0.08)* |
| | | | 0.75 | 0.44 (0.10)* |
| | | 18 | Control | 0.74 (0.11) |
| | | | 25.00 | 0.04 (0.01)* |
| | | | 12.50 | 0.02 (0.01)* |
| | | | 6.25 | 0.17 (0.08)* |
| S. richteri | 1 | 19 | Control | 0.61 (0.25) |
| | | | 3.15 | 0.24 (0.11) |
| | | | 1.50 | 0.46 (0.18) |
| | | | 0.75 | 0.10 (0.06) |
| | | 20 | Control | 0.82 (0.08) |
| | | | 25.00 | 0.04 (0.01)* |
| | | | 12.50 | 0.07 (0.04)* |
| | | | 6.25 | 0.16 (0.10)* |
| S. richteri | 2 | 21 | Control | 0.70 (0.27) |
| | | | 3.15 | 0.17 (0.16) |
| | | | 1.50 | 0.26 (0.17) |
| | | | 0.75 | 0.16 (0.12) |
| | | 22 | Control | 0.96 (0.04) |
| | | | 25.00 | 0.02 (0.02)* |
| | | | 12.50 | 0.14 (0.07)* |
| | | | 6.25 | 0.02 (0.01)* |
| Hybrid | 1 | 23 | Control | 0.74 (0.09) |
| | | | 3.15 | 0.10 (0.03)* |
| | | | 1.50 | 0.10 (0.03)* |
| | | | 0.75 | 0.43 (0.15) |
| | | 24 | Control | 0.98 (0.08) |
| | | | 25.00 | 0.20 (0.09)* |
| | | | 12.50 | 0.37 (0.04)* |
| | | | 6.25 | 0.45 (0.08)* |
| Hybrid | 2 | 25 | Control | 0.59 (0.15) |
| | | | 3.15 | 0.28 (0.09) |
| | | | 1.50 | 0.25 (0.10) |
| | | | 0.75 | 0.34 (0.14) |
| | | 26 | Control | 0.85 (0.07) |
| | | | 25.00 | 0.04 (0.01)* |
| | | | 12.50 | 0.10 (0.04)* |
| | | | 6.25 | 0.20 (0.08)* |

*Significantly different from the control (0.00 ppm).
SE: standard error.

We claim:

1. A method for repelling arthropods comprising treating a subject or an object with an arthropod repelling composition comprising an arthropod repelling effective amount of an active compound selected from the group consisting of at least one clerodane having the formula 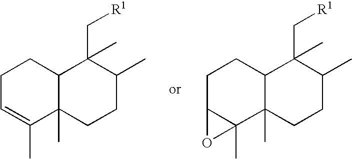
in which R¹ is H, halogen, formyl, a straight chain or branched C₁₋₄ saturated alkyl, a straight chain or branched C₂₋₄ unsaturated alkyl, or an aryl containing 6-10 carbon atoms in the ring skeleton thereof, wherein R¹ is unsubstituted or substituted with one or more substituents, which are the same or different, selected from the group consisting of oxo, OR², CO₂R², and OC(O)R², wherein R² is H, a straight chain or branched C₁₋₃₀ saturated alkyl, a straight chain or branched C₂₋₃₀ unsaturated alkyl, or an aryl comprising 6-10 carbon atoms in the ring skeleton thereof; wherein R² is unsubstituted or substituted with one or more substituents selected from the group consisting of halogen, amino, hydroxyl, oxo, thio, cyano and nitro: and mixtures thereof: optionally a carrier, optionally an arthropod repellant, optionally an insecticide, optionally intermedeol, and optionally spathulenol; said method does not involve the use of any compound isolated from Callicarpa species other than callicarpenal, intermedeol, and spathulenol, and said composition does not contain any compound isolated from Callicarpa species other than callicarpenal intermedeol, and spathulenol.

2. The method according to claim 1, wherein, said active compound is selected from the group consisting of callicarpenal, 13,14,15,16-tetranorclerod-3-en-12-ol, 13,14,15,16-tetranorclerod-3-en-12-oic acid, β-epoxycallicarpenal, α-epoxycallicarpenal, or mixtures thereof.

3. The method according to claim 2, wherein said callicarpenal is isolated from, at least one member selected from the group consisting of Callicarpa americana, Callicarpa japonica, or mixtures thereof.

4. The method according to claim 1, wherein said composition further comprises spathulenol.

5. The method according to claim 1, wherein said composition contains a carrier.

6. The method according to claim 1, wherein, said subject is a mammalian subject.

7. The method according to claim 6, wherein, said mammalian subject, is a human subject.

8. The method according to claim 6, wherein said treating comprises applying said composition to the skin of said subject.

9. The method according to claim 7, wherein said treating comprises application of said composition to an article, which article is worn by said human subject.

10. The method according to claim 1, wherein the concentration of said active compound in said composition is from about 0.001% by weight to 99% by weight of the composition.

11. The method according to claim 1, wherein said -active compound is synthetic.

12. The method according to claim 1, wherein said arthropods are mosquitoes or fire ants.

13. The method according to claim 1, wherein said composition further comprises intermedeol.

14. A composition for repelling arthropods comprising an arthropod repelling effective amount of intermedeol and at least one member selected from the group consisting of callicarpenal, 13.14,15,16-tetranorclerod-3-en-12-ol, 13,14,15,16-tetranorclerod-3-en-12-oic acid, β-epoxycallicarpenal, α-epoxycallicarpenal, and mixtures thereof, optionally a carrier, optionally an arthropod repellant, and optionally an insecticide; said composition does not contain any compound isolated from Callicarpa species other than callicarpenal intermedeol, and spathulenol.

15. The composition according to claim 14, therein intermedeol, callicarpenal, 13,14,15,16-tetranorclerod -3-en-12-ol, 13,14,15,16-tetranorclerod-3-en-12-oic acid, β-epoxycallicarpenal, and α-epoxycallicarpenal are synthetic.

16. The composition according to claim 14, wherein said callicarpenal and intermedeol are isolated from at least one member selected from the group consisting of Callicarpa americana, Callicarpa japonica, or mixtures thereof.

17. An arthropod repellant composition, comprising an arthropod repelling effective amount of at least one clerodane having the formula 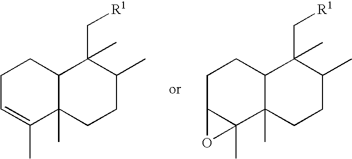
wherein R¹ is H, halogen, formyl, a straight chain or branched C₁₋₄ saturated alkyl, a straight chain or branched C₂₋₄ unsaturated alkyl, or an aryl containing 6-10 carbon atoms in the ring skeleton thereof, wherein R¹ is unsubstituted or substituted with one or more substituents, which are the same or different selected from the group consisting of oxo, OR², CO₂R², and OC(O)R², wherein R² is H, a straight chain or branched C₁₋₃₀ saturated alkyl, a straight chain or branched C₂₋₃₀ unsaturated alkyl, or an aryl comprising 6-10 carbon atoms in the ring-skeleton thereof, wherein R² is unsubstituted or substituted with one or more substituents selected from the group consisting of halogen, amino, hydroxyl, oxo, thio, cyano and nitro; and a carrier; said composition does not contain any compound isolated from Callicarpa species other than callicarpenal, intermedeol, and spathulenol.
